(19) United States
(12) Patent Application Publication
(10) Pub. No.: US 2005/0131841 A1
(43) Pub. Date: Jun. 16, 2005

(54) Stamp book with order information carrier

(76) Inventor: Hans Demanowski, Berlin (DE)

Correspondence Address: MAYER, FORTKORT & WILLIAMS, PC, 251 NORTH AVENUE WEST, 2ND FLOOR, WESTFIELD, NJ, 07090, US

(21) Appl. No.: 11/013,675

(22) Filed: Dec. 16, 2004

(30) Foreign Application Priority Data
Dec. 16, 2003 (DE) DE 203 19 993.6
Jan. 16, 2004 (DE) 20 2004 000 711.8

(51) Int. Cl. G06F 17/60

(52) U.S. Cl. 705/401

(57) ABSTRACT

The invention relates to a stamp book comprising at least one stamp sheet (1) and a card-type order information carrier (3), wherein the stamp sheet (1) and the order information carrier (3) are detachably connected with each other, and wherein the order information carrier (3) is prepared for postal transportation and comprises order information (13).

### FIELD OF THE INVENTION

The invention relates to a stamp book comprising at least one stamp sheet. Stamps are any objects carrying a value, such as postage stamps, transportation tickets, event tickets or other stamps or bills carrying a value. Postage stamps are typically printed on one side and provided on the other side with an adhesive layer, and this adhesive layer may be self-adhesive or adhesive after moistening. A stamp sheet, for instance a postage stamp sheet, is a single sheet, on which typically a multitude of stamp imprints are applied. Stamps of a stamp sheet are for instance separated from each other by a perforation and can be individualized by tearing the perforation apart.

### PRIOR ART AND BACKGROUND OF THE INVENTION

In the practice, postage stamp books of the above type are known in the art. In most cases, such a postage stamp book comprises a multitude of postage stamp sheets, and the various postage stamp sheets are detachably connected with each other along an edge. Usually, an adhesive binding with a binding glue of low binding force is employed. The lower binding force compared to the overall stability of a postage stamp sheet permits the separation of complete postage stamp sheets from the postage stamp book.

From the customer's point of view, for the sales of stamps, a dense sales network is desirable, in order that the customer needs not to go or drive long ways for buying stamps from a counter. From the stamps sales organization's point of view, for instance of a postal transportation organization, it is however desirable to have to operate as few retail outlets as possible. Further, the counter sales of stamps is a business in deficit, since personnel, invoicing systems etc. need to be held available in every retail outlet, without the possibility to charge a customer the handling costs. In total, the sales of stamps is to a high degree improvable.

From the document DE 295 15 576 U1 relating to different considerations, an index print card is known, which is detachably connected with an order card. By means of the order card, copies of film negatives or slides can be reordered. This order card records order information about the number of pictures, picture quality and size as well as the address of the person who places an order. A simplification of the sales or a saving of long ways is however not achieved, since the person who places an order has to bring the order card including the negative film to the photographic laboratory and collect the remade copies at a later point of time, since the order card is not prepared for postal transportation.

### TECHNICAL OBJECT OF THE INVENTION

It is therefore the technical object of the invention to provide a stamp book, which permits more efficient and at the same time customer-friendly sales procedures.

### BASICS OF THE INVENTION AND PREFERRED EMBODIMENTS

For achieving this object, the invention teaches a stamp book comprising at least one stamp sheet and an order information carrier, wherein the stamp sheet and the order information carrier are detachably connected with each other—preferably along an edge—, and wherein the order information carrier is prepared for postal transportation and comprises order information.

The preparation for postal transportation comprises in particular the application of a person-readable and/or machine-readable address, for instance of a centralized stamps sales organization of a business unit distributing the stamps.

It is achieved, by the invention, that the customer after taking the last stamp from the stamp book (or even before) can use the order information carrier and post it by taking it to a letterbox. A centralized stamps sales organization, for instance of a postal transportation organization, can then send the customer by mail a new stamp book, which suitably again contains an order information carrier. Thereby, the customer can provide new stamps, in a simple way and without going or driving long ways. For the stamps sales organization, it is advantageous that only a central sales unit is required and the counter sales with the costs related therewith are prevented, at least however subtantially reduced.

The order information carrier may have the form of a card or of an envelope. A card-type or envelope-type order information carrier is preferably made of stable carton, if applicable polymer-reinforced or coated or laminated, corresponding to a postcard or a mail envelope. However, other materials may also be used. For instance, the order information carrier may comprise a polymeric carrier as a main component. Advantageously, the dimensions correspond to a standardized postcard size or mail envelope size.

With an envelope-type configuration of the order information carrier, it is possible, for the stamps sales organization, by using the same order information carrier, to send the ordered stamps back to the customer. For instance in the case of postage stamps, special issues etc. having special sizes or book forms can easily be sent to the customer. Thereby, it is also possible, for the stamps sales organization, to distribute any remaining stock of such special issues in a simple way.

Preferably, an envelope-type order information carrier is prepared for multiple use, for instance by providing it with at least one polymeric layer. The order information may comprise fields for filling-in a customer address and/or an invoice address.

For the reuse of the envelope-type order information carrier, various embodiments are possible. For instance, the order information carrier may include the address of the stamps sales organization. Then the customer only needs to post the order information carrier, if applicable after filling-in further order information. The receiving stamps sales organization can then put the ordered stamps into the order information carrier, and return the filled-up order information carrier back to the customer. For this purpose, an address label carrying the customer address can be glued over the field with the address of the stamps sales organization. In this embodiment, it would be recommendable that the address label is provided with an adhesive layer, which does not create a permanent connection with the surface material of the order information carrier, but a detachable glue connection. Such glue connections are known in the art, for instance in the sector of magazines and journals. Then the customer can easily reuse the order information carrier, by peeling the address label off, thus the address of the stamps sales organization becoming visible again. This cycle can be repeated as often as desired, until the order information carrier is worn out. In this context it is also possible that the order information, which the customer fills in, for instance type, quantity and value of the stamps, is applied by means of a corresponding label. Then the stamps sales organization can in turn remove this order information label after receipt of the order information carrier and handle it in the same way same as an order sheet. In so far it will be recommendable when a stamp book according to the novelty is bought for the first time, to include a bundle of several order information carrier labels for the successive consumption by the customer.

In lieu of an address label, it may also be provided that a transparent pocket for receiving an address card is arranged over the field with the address of the stamps sales organization. Then the stamps sales organization can slide thereinto the address card with the customer address. The customer can then after receipt remove this address card again and thus reuse the order information carrier in the above way for a new order.

In another alternative embodiment, the envelope-type order information carrier can be provided with the customer address, by means of which the stamps sales organization makes the shipment to the customer. For the shipment to the stamps sales organization by the customer, there may however be no address of the stamps sales organization. Rather, by a postal transportation organization, which in the case of ordering postage stamps may be identical with the sales organization or a linked enterprise, an address-less detection that it is an order information carrier may take place, and in case of such a positive detection an automatic shipment to the stamps sales organization is performed, without consideration of the applied customer address. Such a detection may for instance be made on the basis of the format of the order information carrier. The term format comprises here at least one or more of the following features: outside dimensions (defined width and/or height of the order information carrier, preferably different from standardized envelope shapes), color, material, preferably machine-readable detection element (e.g. barcode, proprietary imprint such as logo etc.), proprietary free symbol etc. In any case, it will be recommendable that this is a detection feature, which is not present at normal postal transportation goods or differs from features usually applied to normal postal transportation goods.

The connection between the stamp sheet and the order information carrier preferably is an adhesive binding, by means of which the individual stamp sheets and the order information carrier are glued to each other like a booklet. In principle, however, any other kind of binding or stapling is also possible. Usually, the binding or stapling will be arranged outside the region of the stamps and/or of the order information carrier.

Individual stamp sheets and/or the order information carrier may have in the region of the adhesive binding and in parallel thereto a perforation, by means of which the stamp sheets can be separated from each other, and the order information carrier can be separated from the stamp sheets.

Further, the adhesive binding may be a spine gluing by means of a binding glue of low binding force, so that individual stamp sheets and the order information carrier can be separated by tearing-off at the edge.

A stamp sheet may in particular comprise a multitude of stamps connected with each other and detachable from each other, the number of the stamps being in most cases 2 to 100, in particular 2 to 20, for instance 10. A stamp book may comprise a multitude of stamp sheets, for instance 2 to 100, in particular 2 to 20, e.g. 10 stamp sheets. The stamp sheets are preferably connected with their printed-on side showing upwards and together with the order information carrier, with the order information carrier being preferably arranged at the lowermost position. The order information carrier may however also be arranged on top or between two stamp sheets. In the latter case, the order information carrier may in particular be arranged above the lowermost stamp sheet, thus the customer being reminded to ship the order information carrier, before the last stamp sheet is used up.

It is recommended that the order information carrier is provided with a stamp or a frank. Thereby a customer can completely use up the stamps of a stamp book and nevertheless ship the order information carrier without further measures. It is also possible that by a frank on the order information carrier, which is not invoiced to the customer when buying the stamp book, a special incentive for buying stamp books according to the invention and the use of the order information carrier is provided.

The order information carrier or order information label may contain order fields to be activated as order information, and the desired new stamp book types to be delivered can be defined by the activation of an assigned order field. The fields to be activated are on the order information carrier for instance printed-on boxes or circles, which the customer can activate by ticking or marking. Different stamp book types comprise for instance transportation tickets or postage stamp books of only one transportation fee value or one postage stamp value or stamp books with a mixture of different transportation fee values or postage stamp values, and either stamp sheets with stamps of different values being however identical within a stamp sheet are connected with each other or a stamp sheet contains stamps of different values. Instead of marking by ticking or the like, marking may also be performed by filling in the desired quantity of the desired stamp book type.

The order information may comprise an identification element, in particular a machine-readable identification element, the identification element comprising an individualizing code, for instance in the form of a customer number. Machine-readable identification elements may be exclusively machine-readable or also (in addition) person-readable. Insofar, beside a barcode, machine-readable symbols (numbers and/or letters), transponders with a storage unit, where the identification element is stored in and readable from, etc. may also be used. In the case of the individualizing code, it will be recommendable that this is not only machine-readable but also person-readable. Alternatively, the individualizing code may also be printed-on separately in a person-readable manner. The identification element may be arranged immediately on the order information carrier, since even with multiple use for instance the customer number remains unchanged. It is however also possible to dispose the identification element together with other order information on an order information label.

For instance a customer number as a part of an identification element is individualizing, since there is a one-to-one correlation in the mathematical sense between customer and customer number, i.e. there are no possibilities of multiple correlations. Customer numbers may be built up in the most various ways. For instance they may be continuous numbers increasing by 1 for every new customer. It is however also possible to establish the customer number according to a secret number by a random generator, and assign it to the customer after having positively tested the random number for being free. Further it is possible to use a telephone number, an email address or the like as the customer number, since these are not assigned twice and are inherently individualizing. In addition, a customer anyway retains such data, so that the customer number is always available to the customer.

In any case, at the occasion of a first purchase of a stamp book according to the invention in a retail outlet of a stamp sales organization, the customer number is assigned to the specifically buying customer and remains as an option after that unchanged for this customer. By the assignment, customer information, such as address, telephone number, email address, bank account etc. can be recorded and stored in a central memory unit together with the respective customer number. By means of the recorded bank account, a customer can for instance participate in a direct debit authorization method of payment when ordering further stamp books using the order information carrier according to the invention. Upon receipt of an order information carrier of the customer at the central sales office, then the customer information can be called off from the central memory unit and can be used for the shipment of the ordered stamp book and if applicable for the collection of the thus due purchasing price. It will be recommendable that all order information is machine-readable or is read by a machine. Thereby, the central sales organization can be operated to a high degree automatically.

In detail, the procedure is for instance as follows. At the first purchase of a stamp book according to the invention in a retail outlet the customer will have to be registered once under assignment of the individualizing code, for instance the customer number, and the customer number is either handed over to the customer or is already applied on the order information carrier. At the same time, the customer information described above and obtained from the customer is stored in the central memory unit, together with the reference to the customer number. This procedure is in so far advantageous, since for instance information about the customer's bank account information needs not to be recorded on the order information carrier at a repurchase by mail delivery of an order information carrier, and thus a customer needs not to make such information accessible to third parties when shipping the order information carrier. If now the customer for instance requests a new stamp book or new stamps after using-up the first stamp book with the order information carrier, then by means of the identification element the information about the customer stored in the central memory unit can be checked, and the invoice amount can be debited to the customer's bank account, for instance by the direct debit authorization method of payment, and as an option a payment receipt can be sent to him.

In the case of a card-type order information carrier, the new order information carrier requested by the customer again contains an order information carrier with the customer-specific identification element etc. For this procedure it is advantageous, if for stamp books provided for the first sale in the retail outlet, a separable order information carrier duplicate containing a copy of the identification element and fields for the entry of customer information, such as customer address and/or bank account information is provided. Then a sales person in a retail outlet only needs to generate an identification element, for instance a customer number, fill it in on the order information carrier and assign it to the order information carrier duplicate or enter it thereon, and to complement the checked customer information on the order information carrier duplicate.

In the case of the envelope-type order information carrier, the stamp book or the stamps are transported to the customer by using the once or repeatedly usable order information carrier therein.

The entry of the customer information into a central memory unit can in principle be made from the order information carrier duplicate together with other jobs in the retail outlet or another central entry point, thus the counter duty being relieved and accelerated. When shipping the new stamp book or stamps to a customer, whose customer number etc. is already stored, the order information carrier of the shipped stamp book or stamps can already include all necessary information. This easily takes place in the central sales unit by using the information stored in the central memory unit. Then a customer only needs to apply markings with regard to the desired stamp books or stamps, to sign and ship the order information carrier.

A stamp book with a card-type order information carrier intended for resale needs not to have an order information carrier duplicate.

Generally, a shipment of a stamp book in the above variants can be performed, as soon as the due payment amount has successfully been debited.

In an alternative and particularly simple method, the card-type order information carrier is not provided with any customer-specific information at all. A customer has then to enter all necessary information, in particular address and if applicable bank account information for the purpose of the direct debit authorization method of the payment of the amount due with the order every time on the order information carrier and then ship the order information carrier. Checks to be made for a first purchase in a retail outlet are not required, thus the counter duty being further relieved. In this variant it will be recommendable to add a pre-stamped envelope (preferably with the address imprint of the stamp sales organization, for instance the postal transportation organization) to the stamp book, for instance connect it therewith, said pre-stamped envelope being separable and sealable, and whereinto the order information carrier can be put for the purpose of shipment. Thereby third parties cannot get knowledge in particular of the filled-in bank account information in the course of the mail delivery.

In a variant without direct debit authorization, a filled-in money transfer order carrier payable to the stamps sales organization is added to the stamp book, for instance connected therewith in an analogous manner as the other components. The money transfer order carrier then contains in the field purpose of transfer a transaction code, which is unique. The order information carrier preferably also contains this transaction code. As soon as the customer has paid by using this money transfer order carrier, and the credit has been booked by the stamps sales organization, the shipment of the ordered stamp book takes place, the determination of the receiver, his address etc. being made by assignment of the transaction number to a customer number or other customer information. It will be recommendable that the customer number establishes a part of the transaction code.

The invention further relates to a method according to claim 11, wherein all above and below considerations about the stamp books in the respective variants are to be applied in an analogous manner to the method according to the invention.

In the following, the invention is described in more detail with reference to figures representing examples of execution only. There are:

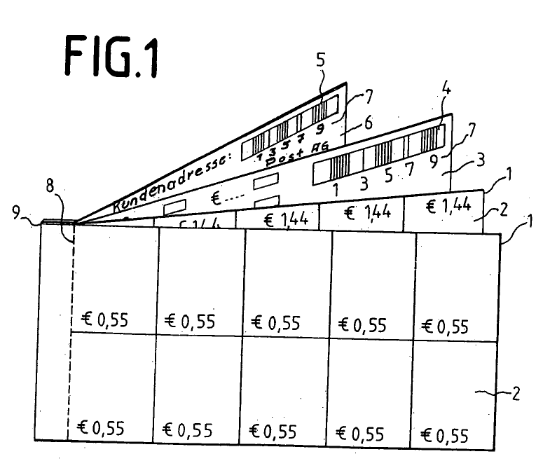

FIG. 1 a postage stamp book with an order information carrier duplicate according to the invention in a first variant,

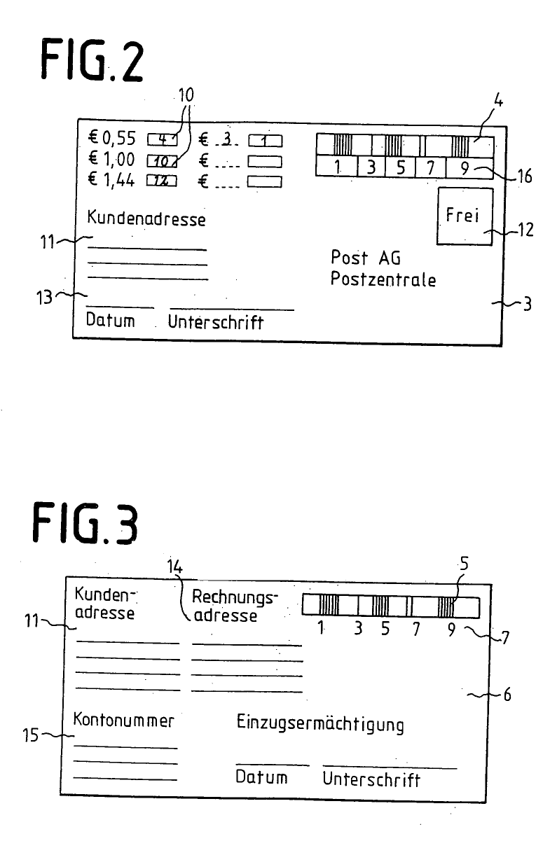

FIG. 2 a detail view of an order information carrier of the subject matter of FIG. 1,

FIG. 3 a detail view of an order information carrier duplicate of the subject matter of FIG. 1,

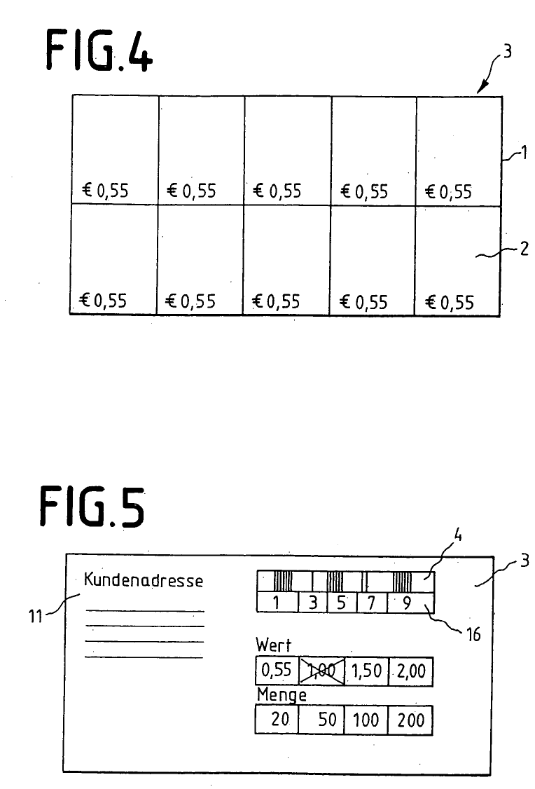

FIG. 4 a postage stamp book with an order information carrier according to the invention in a second variant,

FIG. 5 the subject matter of FIG. 4 in a rear view,

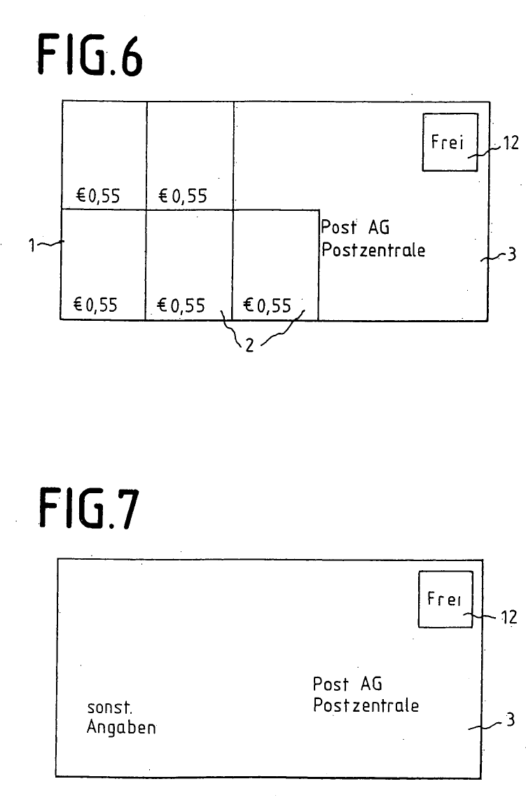

FIG. 6 the subject matter of FIG. 4, with part of the postage stamps having been taken out,

FIG. 7 the subject matter of FIG. 4, with all postage stamps having been taken out, and

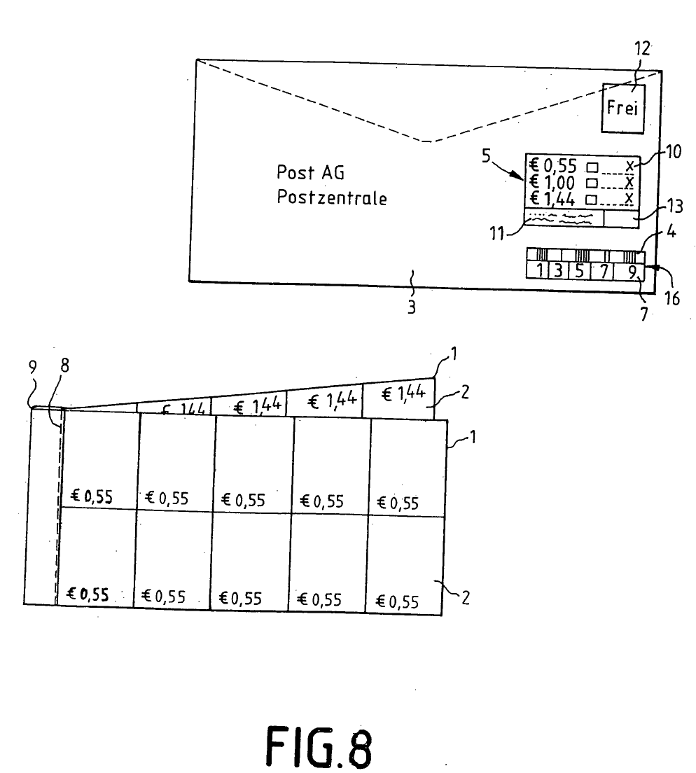

FIG. 8 a postage stamp book with the components stamps and order information carrier in an envelope form.

In FIG. 1 can be seen a postage stamp book, comprising several postage stamp sheets 1 with postage stamps 2, an order information carrier 3 and an order information carrier duplicate 6. The order information carrier 3 and the order information carrier duplicate 6 are arranged at the bottom of the postage stamp book. An adhesive binding 9 connects the stamp sheets 1, the order information carrier 3 and the order information carrier duplicate 6 with each other. For separating from each other, the postage stamp sheets 1 as well as the order information carrier 3 and the order information carrier duplicate 6 are provided with a perforation 8. From FIG. 1 can further be seen that the order information carrier 3 carries an identification element 4 with the customer number 7, and the order information carrier duplicate 6 carries a copy 5 of the identification element with the customer number 7. With regard to information to be filled in, it will be recommendable that the fields to be filled in or activated (other than shown for the sake of simplicity) are arranged on top of each other, and that means for automatic duplication are provided, in order to prevent unnecessary double filling-in.

In the representation of FIG. 1, the values of the postage stamps 2 of different postage stamp sheets 1 are different, within one postage stamp sheet however identical. Of course, the values of all postage stamps of a postage stamp book may be identical; in the practice this will probably be preferred, since then the production processes are easier.

FIG. 2 shows an order information carrier 3 for reordering postage stamps. Preferably, the order information carrier 3 is equipped with activatable order fields 10, fields for filling-in the customer address 11 and fields for date and signature 13. In order not to cause additional costs for the customer when ordering the postage stamps, the order information carrier is provided with a free postage stamp or a frank 12 for free delivery by the postal transportation organization. Preferably, the order information carrier 3 includes the address of the central sales unit of the postal transportation organization. The order information carrier 3 further comprises an identification element 4, in this case an individualizing barcode, including a field 16 for entering the customer number 7.

In FIG. 3 is shown an order information carrier duplicate 6, which has to be filled in by the customer at the first purchase of a postage stamp book in the retail outlet of a postal transportation organization and is kept there for further use. This order information carrier duplicate 6 receives the personal information about the customer, such as bank account information 15, customer address 11 and invoice address 14. The order information carrier duplicate 6 contains a copy 5 of the identification element 4 of the order information carrier 3. Under this identification element 4 or the customer number, the customer information is stored in the central memory unit of the postal transportation organization, and reference is made to the above explanations with regard to the sales procedures.

A new postage stamp book to be shipped by means of the order information carrier 3 as a resale item upon an order can be configured analogously to the representations of FIG. 1, needs however not to have an order information carrier duplicate 6.

In the variant of FIG. 4, the order information carrier 3 is configured as a carrier for self-adhesive postage stamps 2. For this purpose, a single postage stamp sheet 1 is connected on its surface with the one side of the order information carrier 3. It would be recommendable here that the side of the order information carrier 3 directed toward the postage stamp sheet 1 comprises a coating permitting easy detachment of one or several of the self-adhesive postage stamps 2. This may for instance be achieved by an a real coating with a polymer having poor adhesion properties with regard to the self-adhesive glue used for the postage stamp 2. Polymers suitable for this purpose are for instance polyolefins, such as polyethylene, polypropylene etc, or also polymers on silicon basis. In this variant, it can also be provided that the postage stamps 2 of the in particular one postage stamp sheet 1 are not connected immediately, but only by means of the order information carrier 3 with each other.

In particular a comparison of FIGS. 4 to 7 shows that the side of order information carrier directed toward the postage stamp sheet 1 may be printed on, for instance with the address of the stamp sales organization and a frank 12. Further, machine-readable information may be arranged on this side. It may be recommendable that this side is not intended for writing-on by the customer or other persons, since the coatings described above will not permanently carry such inscriptions. Therefore, an printing-on will also take place before the application of the coating. Various fields to be filled-in by persons may however be arranged on the opposite side of the order information carrier 3.

In FIG. 8 can be seen a postage stamp book, comprising several postage stamp sheets 1 with postage stamps 2, an order information carrier 3. The order information carrier 3 has an envelope form, and the order information carrier 3 is adapted so to receive the postage stamp sheets 1. The postage stamp sheets 1 are connected by an adhesive binding 9. For separating from each other, the postage stamp sheets 1 are provided with a perforation 8. From FIG. 1 can further be seen that the order information carrier 3 carries an identification element 4 with a customer number 7. With regard to information to be filled in, it will be recommendable that for this purpose at least one order information label 5 is provided. Further can be seen that the order information carrier 3 carries the address of the postage stamps sales organization.

Preferably the order information carrier 3 or the order information label 5, resp., is equipped with activatable order fields 10, fields for filling-in the customer address 11 and fields for date and signature 13. In order not to cause additional costs for the customer when ordering the postage stamps, the order information carrier is provided with a free postage stamp or a frank 12 for free delivery by the postal transportation organization. Preferably, the order information carrier 3 includes the address of the central sales unit of the postal transportation organization. The order information carrier 3 or the order information label 5, resp., further comprises an identification element 4, in this case an individualizing barcode, including a field 16 for entering the customer number 7.

The postage stamps sales organization can then, for returning a filled-up order information carrier 3, glue a label with the customer address on the address of the central sales unit, or to over-glue that address. It will be recommendable that the sections of the order information carrier 3, on which an order information label 5 and/or a customer address label can be applied, comprises a coating, which permits an easy removal of the respective label. This may for instance be achieved by an a real coating with a polymer having poor adhesion properties with regard to the self-adhesive glue used for the label. Polymers suitable for this purpose are for instance polyolefins, such as polyethylene, polypropylene etc, or also polymers on silicon basis.

Different from the figures, the address of the central sales organization and the frank on the one hand and the order information on the other hand may be provided on different sides of the order information carrier 3.

The variants described in the embodiments for postage stamps 2 can of course also be executed in a fully analogous way for other objects carrying a value, such as transportation tickets etc.

FIG. 1

Customer address

FIG. 2

| | | |
|---|---|---|
| Customer address | | Frank |
| | Address of | |
| | central sales unit | |

| | |
|---|---|
| Date | Signature |

FIG. 3

| | |
|---|---|
| Customer | Invoice |
| address | address |

| | |
|---|---|
| Account number | Direct debit authorization |

| | |
|---|---|
| Date | Signature |

FIG. 5

| | |
|---|---|
| Customer address | |
| | Postage value |
| | Quantity |

FIG. 6

| | |
|---|---|
| | Frank |
| Address of | |
| central sales unit | |

FIG. 7

| | | |
|---|---|---|
| | | Frank |
| | Address of | |
| | central sales unit | |
| Other information | | |

FIG. 8

| | |
|---|---|
| | Frank |
| Address of | |
| central sales unit | |

1. A stamp book comprising at least one stamp sheet (1) and a card-type or envelope-type order information carrier (3), wherein the stamp sheet (1) and the order information carrier (3) are detachably connected with each other, and wherein the order information carrier (3) is prepared for postal transportation and comprises order information (13).

2. A stamp book according to claim 1, wherein the stamp sheet (1) comprises a multitude of stamps (2) connected with each other and detachable from each other, the number of the stamps (2) being 2 to 100, in particular 2 to 20, for instance 10.

3. A stamp book according to claim 1, wherein the stamp book comprises a multitude of stamp sheets (1), in particular 2 to 100, preferably 2 to 20, for instance 10 stamp sheets (1), the stamp sheets (1) being connected, preferably in a detachable way, along an edge, in particular by an adhesive binding with each other.

4. A stamp book according to claim 1, wherein the stamp sheet (1) or the stamp sheets (1) are stacked with an printed-on side showing upwards and together with the card-type order information carrier (3), with the order information carrier (3) being arranged at the lowermost position, and wherein the order information carrier (3) is connected along an edge, preferably by an adhesive binding, with the stamp sheet (1) or the stamp sheets (1).

5. A stamp book according to claim 1, wherein the envelope-type order information carrier is adapted for receiving one or several stamps (2) or one or several stamp sheets (1), resp.

6. A stamp book according to claim 1, wherein the order information carrier (3) is provided with a postage stamp or a frank (12).

7. A stamp book according to claim 1, wherein the order information comprises at least one identification element (4), in particular a machine-readable identification element, for instance a barcode, and wherein the identification element comprises an individualizing code, for instance in the form of a customer number (7).

8. A stamp book according to claim 1, wherein the order information comprises activatable order fields (10), and desired new stamp book types to be delivered can be defined by activation of an assigned order field (10).

9. A stamp book according to claim 1, wherein the stamp book in addition comprises a separable order information carrier duplicate (6) containing at least one copy (5) of the identification element and/or copy of the individualizing code, and fields for the entry of a customer address (11) and/or bank account information (15).

10. A stamp book according to claim 1, wherein the order information comprises fields for filling-in a customer address (11) and/or an invoice address (14).

11. A method for the sales of stamp books,
i) wherein a stamp book according to claim 1 is sold to a customer,
ii) wherein the customer applies order information on the order information carrier of the stamp book and then hands in the order information carrier after detachment from the stamp sheets or stamps at the mail organization for transportation to the sales organization of the stamp books,
iii) wherein the sales organization, after receipt of the order information carrier and before or after payment of the stamp books ordered according to the order information carrier, hands in the ordered stamp book or the ordered stamp books at a postal organization for transportation to the customer, in the embodiment with an envelope-type order information carrier the order information carrier used in step ii) representing as an option a component of the stamp book shipped in step iii).
